(19) United States
(12) Patent Application Publication
(10) Pub. No.: US 2024/0354835 A1
(43) Pub. Date: Oct. 24, 2024

(54) COMPUTER-BASED SYSTEMS AND METHODS FOR THE GENERATION AND USE OF UNIVERSAL RESOURCE LOCATORS TO DIRECT ONLINE USERS TO IMPROVED WEBPAGES FOR EXECUTING ELECTRONIC TRANSACTIONS

(71) Applicant: Home Depot Product Authority, LLC, Atlanta, GA (US)

(72) Inventors: Apekshith Ramesha, Sugar Hill, GA (US); Chirag Patel, Leander, TX (US)

(21) Appl. No.: 18/136,541

(22) Filed: Apr. 19, 2023

(51) Int. Cl. G06Q 30/0601

(52) U.S. Cl. CPC G06Q 30/0643; G06Q 30/0633

(57) ABSTRACT

A method includes receiving first data indicative of a user selection of a clickable link displayed on a user computing device as part of a first webpage. The first webpage includes a video with instructions for a user to complete a project or task. The project or task requires a plurality of tangible items in order for the user to complete the project or task. The method further includes sending, in response to the receiving of the first data, second data indicative of a second webpage for display by the user computing device. The second data indicative of the second webpage includes third data indicative of a virtual shopping cart in which all of the plurality of tangible items are pre-added to the virtual shopping cart automatically. The first webpage is part of a first website. The second webpage is part of a second website.

### TECHNICAL FIELD

This disclosure relates generally to the creation and use of universal resource locators (URLs), and more particularly to generating and providing customized URLs to online users to direct them to webpages that are customized for executing an electronic transaction.

### BACKGROUND

Online users of the internet frequently view websites have different webpages. Those webpages may include varying content, such as videos, text, images, etc. relating to different topics such as instructions for how to complete a project or task.

### SUMMARY

An illustrative method includes receiving, by one or more processors of one or more computing devices, first data indicative of a user selection of a clickable link displayed on a user computing device as part of a first webpage. The first webpage includes a video with instructions for a user to complete a project or task. The project or task requires a plurality of tangible items in order for the user to complete the project. The method further includes sending, by the one or more processors in response to the receiving of the first data, second data indicative of a second webpage for display by the user computing device. The second data indicative of the second webpage includes third data indicative of a virtual shopping cart in which all of the plurality of tangible items are pre-added to the virtual shopping cart automatically. The first webpage is part of a first website provided by a first entity. The second webpage is part of a second website provided by a second entity. The first entity is different from the second entity.

An illustrative system includes at least one processor and a memory operatively coupled to the at least one processor, the memory having non-transitory computer readable instructions stored thereon that, upon execution by the at least one processor, cause the system to receive first data indicative of a user selection of a clickable link displayed on a user computing device as part of a first webpage or a scanning of an optical code displayed on the user computing device as part of the first webpage. The first webpage includes at least one of video or text comprising instructions for a user to complete a project or task. The project or task requires a plurality of tangible items in order for the user to complete the project or task. The computer readable instructions further cause the system to send, in response to the receiving of the first data, second data indicative of a second webpage for display by the user computing device. The second data indicative of the second webpage comprises third data indicative of a virtual shopping cart in which all of the plurality of tangible items are pre-added to the virtual shopping cart automatically.

An illustrative method includes receiving, by one or more processors of one or more computing devices from a contractor computing device, a request to generate a universal resource locator. The request includes an identification of a plurality of tangible items and at least one labor service. The plurality of tangible items and the at least one labor service are related to at least one of a construction, renovation, or landscaping project. The method further includes generating, by the one or more processors, the universal resource locator in response to the request. The method further includes sending, by the one or more processors, the universal resource locator to the contractor computing device associated with the construction, renovation, or landscaping project. The method further includes receiving, by the one or more processors from a customer computing device, first data indicative of the universal resource locator. The method further includes sending, by the one or more processors in response to the receiving of the first data, second data indicative of a webpage for display by the customer computing device. The second data indicative of the webpage comprises third data indicative of a virtual shopping cart in which all of the plurality of tangible items and charges for the at least one labor service are pre-added to the virtual shopping cart automatically.

### BRIEF DESCRIPTION OF THE DRAWINGS

FIG. 1 is a block diagram illustrating an example computer-based system for generating and providing customized universal resource locators (URLs) to online users, in embodiments.

FIG. 2 is a flow chart illustrating an example method for generating and providing customized URLs to online users, in embodiments.

FIG. 3 is a flow chart illustrating an example method for determining aspects of a user and/or user device and changing a webpage delivered to the user in response to a selection of a generated URL, in embodiments.

FIG. 4 is a flow chart illustrating an example method for generating a customized URL related to a particular construction, renovation, or landscaping project, in embodiments.

FIG. 5 is an example graphical user interface (GUI) illustrating an example browser interface for displaying a custom generated URL to a user along with content related to a project or task, in embodiments.

FIG. 6 is an example graphical user interface (GUI) illustrating an example browser interface for displaying a custom webpage to a user after the user selects a custom generated URL related to a project or task, in embodiments.

FIG. 7 is a flow chart illustrating an example method for generating and providing customized URLs to in-store users while a payment processing system is unavailable, in embodiments.

FIG. 8 is a block diagram illustrating an example computer-based system for generating and providing customized universal resource locators (URLs) and implementing electronic transactions upon navigation to the URL by a user device, in embodiments.

FIG. 9 is a diagrammatic view of an example user computing environment, according to some embodiments.

### DETAILED DESCRIPTION

Described herein are methods, systems, computer readable media, etc. for generating and providing universal resource locators (URLs) on a first webpage to a display of a user device. The URL allows a user to quickly and easily navigate to a second webpage that is relevant to the content viewed on the first webpage. For example a user may be viewing a video or blog post related to do-it-yourself home improvement task or project. A URL may be provide to the user via the first webpage to navigate to another webpage. A selection of that URL may cause the user device to navigate to the second webpage, where the methods systems, and computer readable media described herein are further configured to serve the second webpage to the user device, such that the second webpage may be displayed on the user device, such that the user device's display is customized for executing an electronic transaction related to the do-it-yourself home improvement task or project. For example, the second webpage may include an electronic shopping cart with multiple items automatically pre-added to the shopping cart upon navigation to the second webpage. The multiple items may be items used for completing the do-it-yourself home improvement task or project. Various embodiments described herein therefore include technical aspects that reduce the number of pages, websites, or applications a user may have to visit and/or use to execute an electronic transaction related to a given task or project using a client electronic device. The various embodiments described herein therefore further include technical aspects that reduce the number of clicks and/or actions taken by users and their devices to execute an electronic transaction related to a given task or project while using a client/user electronic device. The various embodiments described herein also provide for improved technical aspects of a backend system used to generate the URLs displayed in the first webpage and execute the electronic transaction related to a given task or project via the second webpage.

In particular, the methods, systems, and computer readable media described herein include the generation of universal resource locators (URLs) that may be recognized by a computing device to operate along with or in a web browser. Web browsers may be used to visit webpages of a website. As used herein, a website refers to a collection of one or more webpages. For example, a webpage may be navigated to by entering a universal resource locator (URL) into a web browser, such as www.homedepot.com. This may cause the browser to display a webpage for the website. However, other URLs may navigate to other pages of a website. For example, a URL may be distinct from www.homedepot.com and display a different webpage but may still be part of the same website as the first webpage. For example, a URL www.homedepot.com/home-decor/may navigate to a second webpage of the website. The second webpage may still be considered part of the first website because, for example, the domain name in the URL may indicate a host of the website (e.g., homedepot). As such, upon selection by a user, a URL may lead to a webpage of a website that the user is already viewing, or may lead to a webpage of a different website than that already being viewed. Accordingly, a user may use a client electronic device to operate a browser to navigate to multiple websites and multiple webpages of those websites. In this way, a graphical user interface (GUI) of a user electronic device may be modified to display varying content as described herein.

In various embodiments, URLs may be provided to or displayed to the user on their electronic device in various ways. For example, a URL may be embedded in a video displayed on a webpage and available for selection by a user at a certain time in the video. The URL may be displayed as text or otherwise available for selection by a user as a hyperlink (even if, for example, the exact text of the URL is not displayed on the webpage). Such a URL or hyperlink may be part of text of a webpage, such as in a description of a video, a user comment on the webpage, part of a blog post, etc. The URL may also be made available to a user by way of a visual code, such as a QR code. The QR code may be scannable, for example, using a camera of a smart phone by the user. The smart phone may then navigate to the second webpage using the URL encoded in the QR code. As such, a URL may be selected and/or provided for selection to a user in various ways.

Various methods, systems, and computer readable media described herein also include functionality for generating the URLs described herein, receiving selections of those URLs, determining information related to the already generated URL to send to a display of a user device, and facilitating an electronic transaction related to project or task of the first website. For example, a server may be used to generate a URL related to particular project or task, such as building a flower box. The server may define the URL (e.g., www.homedepot.com/DIY-flower-box/) and receive information related to all the tangible items a user may use to build the flower box. In a database, the server may save the URL along with identifiers of the specific tangible items. In this way, when a user selects the URL in the future, the server can check the database to determine the items related to the URL (and the project or task). The server may then provide to the user device, for display on the user device, information related to the project or task including the tangible items. The tangible items may be automatically loaded into an electronic shopping cart on the webpage navigated to in response to a user selection of the URL. In this way, the user may process an electronic transaction to purchase the tangible items and have them delivered to or have them be picked up by the user. The server may further communicate with other aspects of an online shopping website to further carry out the electronic transaction, such as pricing systems, delivery/fulfillment systems, etc.

The methods, systems, and computer readable media described herein therefore provide improved technical solutions for technical problems by causing a user device to quickly navigate to a second webpage related to a first webpage, where an electronic transaction related to tangible items concerning the content of the first webpage may be executed. For example, if a user is reading a blog or watching a video about a particular project or task using a web browser, the user may select a URL or otherwise use a URL to navigate to a second webpage on the same user device or a different user device. On this second webpage, the user may be presented with information related to the tangible items for the project or task without the need to individually search for information related to each item. The embodiments herein may further provide information about recommendations for a delivery/pickup of the tangible items, recommendations for a payment method to buy the tangible items, etc. Such graphical user interfaces (GUIs) as described herein therefore represent an improvement over past GUIs where it was difficult for users to locate information related to a project or task they read about or watch a video about on the internet, including information related to tangible items used to complete such a project or task.

The technical solution of providing and using such URLs and webpages provides several technical advantages. For example, the embodiments described herein reduce the number of clicks, touches, or other interactions taken by a user of a client electronic device to learn about information (e.g., specific tangible items for a task or project, possible payment methods and fulfillment options for the tangible items), take action on such information (e.g., purchase the tangible products in an electronic transaction). Furthermore, the embodiments described herein reduce the number of computing applications a user may need to navigate to learn about the information and take action on such information. Accordingly, the amount of time a user may need to spend on a user electronic device to take advantage of such promotions/discounts may also be reduced using the embodiments described herein, which may in turn reduce the overall amount of time a user may spend using a user electronic device.

Reducing the number of user interactions and/or clicks a user may need to make, reducing a number of applications a user may need to use, and/or reducing the amount of time a user may need to spend on a device may all improve the functioning of various electronic devices. For example, reducing the number of user interactions/clicks, reducing the number of applications navigated to, and reducing the amount of time spent on a device may improve the functioning of the user's client electronic device. As a further example, battery life and usage are common concerns for mobile electronic devices. Using the embodiments described herein, persons using a mobile electronic device will use less processing power, thereby preserving battery life. For example, a client electronic device battery may last longer due to decreased time spent actively using the device, fewer applications being active, etc. The client electronic device may also load webpages more quickly if only a single browser and website/webpage is active, rather than multiple applications and/or websites/webpages. In addition, servers or other computing devices that communicate information to the client electronic device may see decreased loads due to users requesting less information (e.g., through less clicks, fewer applications used, fewer webpages/websites visited, etc.) to learn about tangible products for a project or task and how to procure them. As such, multiple computing devices may functionally improve based on the systems, methods, and computer readable media described herein. In other words, processing loads, battery demand, etc. on various devices may be reduced using the embodiments described herein, all while improving convenience and ease of use for a user.

The technical solution of providing a URL through various methods may also provide technical advantages and solutions over prior systems and methods. For example, if a QR code or other text-based URL is provided as part of a first webpage, a user may use their own device (e.g., a smart phone) rather than the device on which the first webpage is displayed to navigate to the first webpage. Such a configuration is a technical solution for overcoming a technological problem of a lack of context for what a user is viewing. In other words, if a user is looking at a video on a television screen mounted at a train station, for example, use of their smart phone may not be efficient in researching details of the video viewed in the train station. However, with the use of the URLs described herein, the URL may be included in the video so that a user device may quickly navigate to webpage related to the project or task on their own device. In other words, a device on which the first webpage is displayed, and the URL is displayed on may be a different device from the device that navigates to the second webpage using the URL. In various embodiments, the advertisement may not even be on an electronic device, but the URL or QR code may instead be provided on a print advertisement for selection/navigation by a user and their own device. In addition, the first webpage may be part of a different website than the second webpage. This may further solve a technological challenge in understanding what a user is viewing, as current websites may not have an understanding of tangible items related to a project or task described on different websites.

The various embodiments described herein therefore solve technological problems with learning about tangible items related to projects or tasks and learning about information for how to acquire those items, by using the technological solutions necessarily rooted in computer technology described herein to improve performance for user devices, server devices, and for any information exchanged between those devices. For example, based on at least the problems and solutions described herein, at least some embodiments of the present disclosure therefore result in improved functioning of mobile electronic devices, network resources, and/or back end servers (including cloud computing resources).

The methods and systems described herein also represent demonstrable technological improvements over prior website functionality. In other words, the embodiments herein provide for a particular manner of implementing webpages on browsers that result in the technical benefits described herein as opposed to conventional or known webpages/websites.

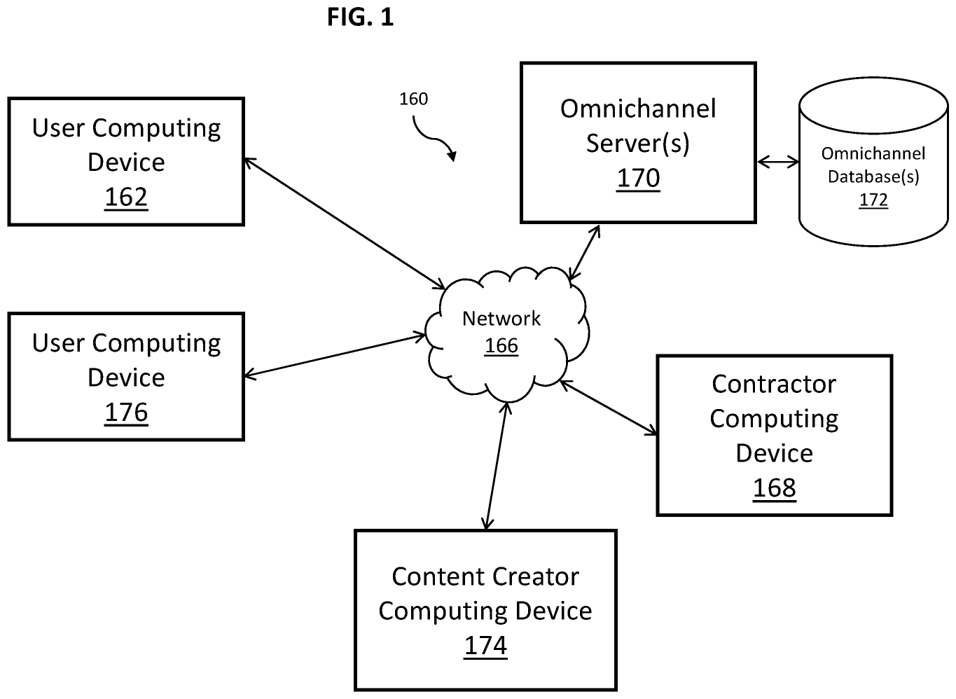

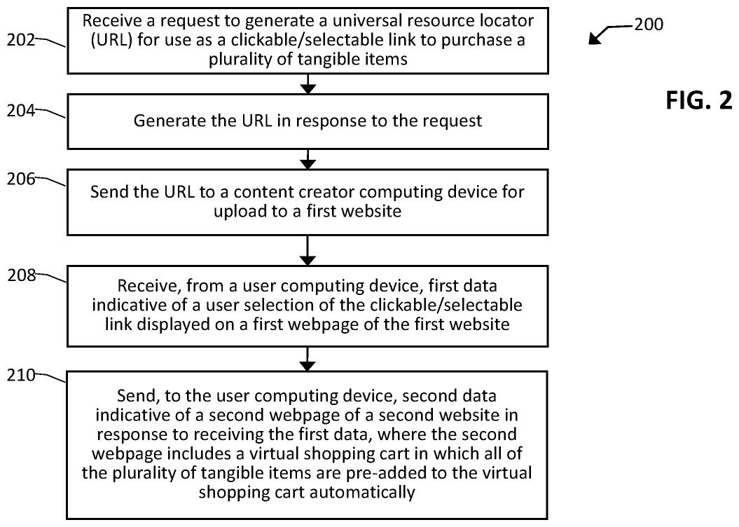

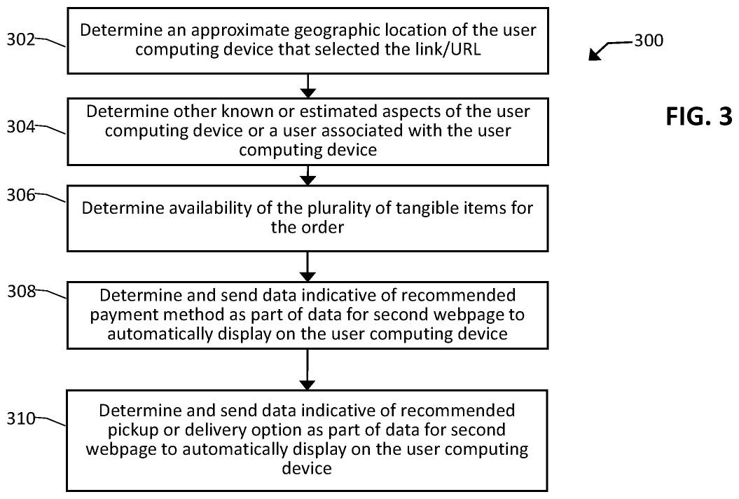

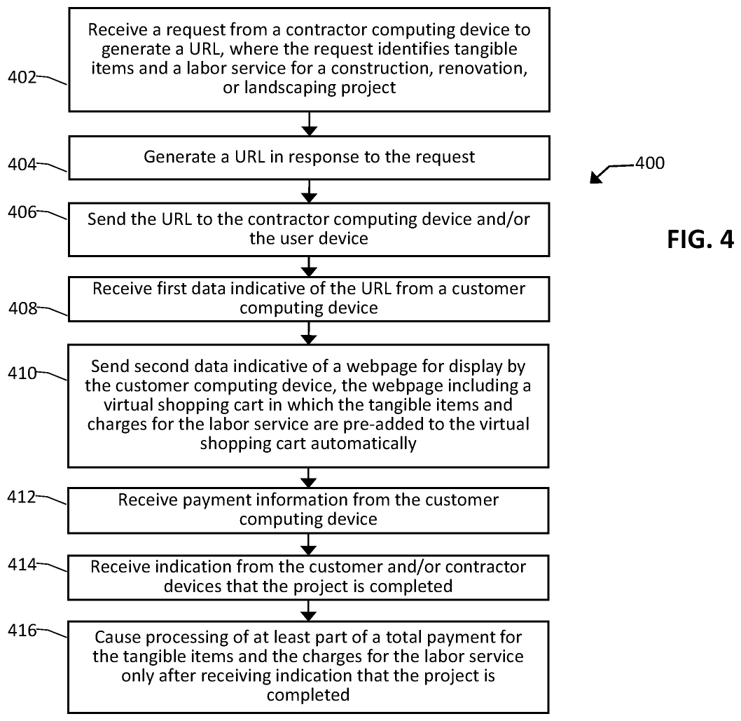

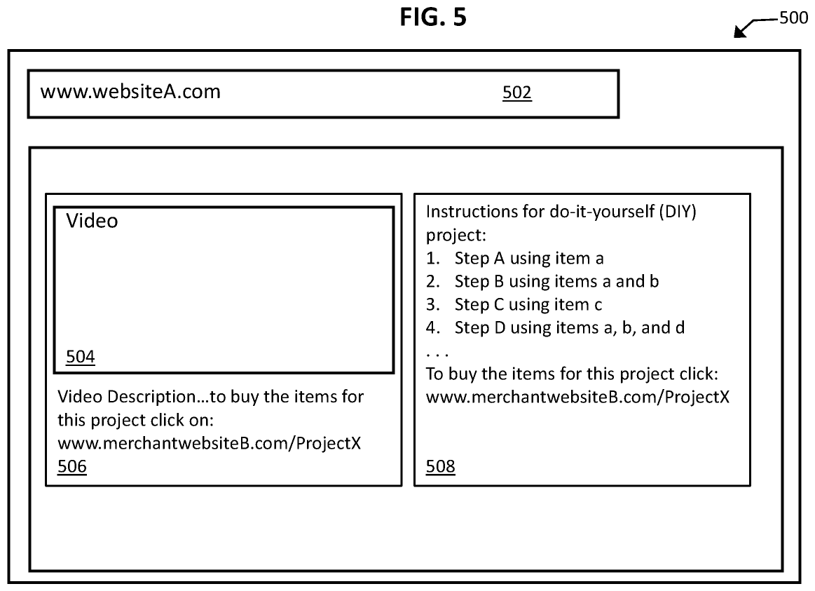

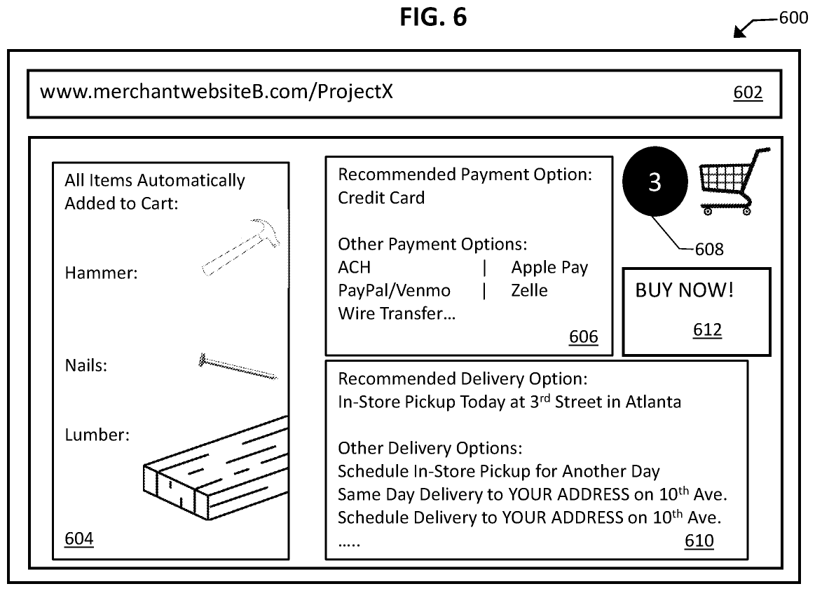

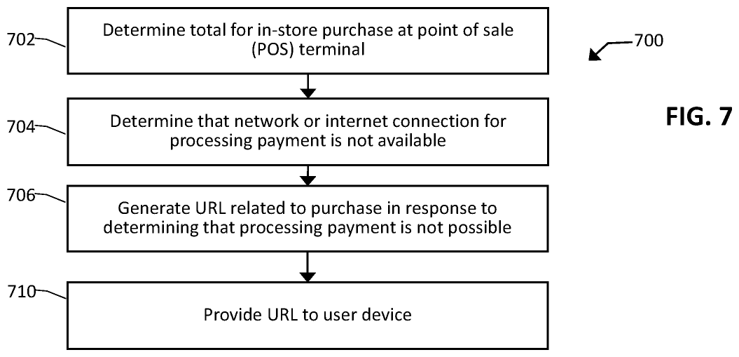

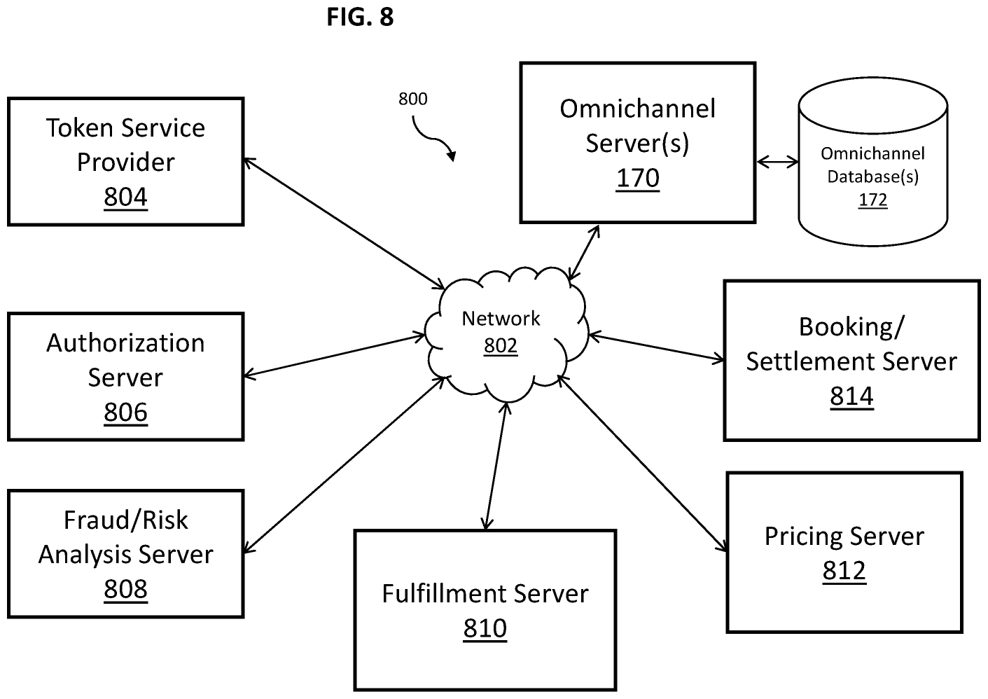

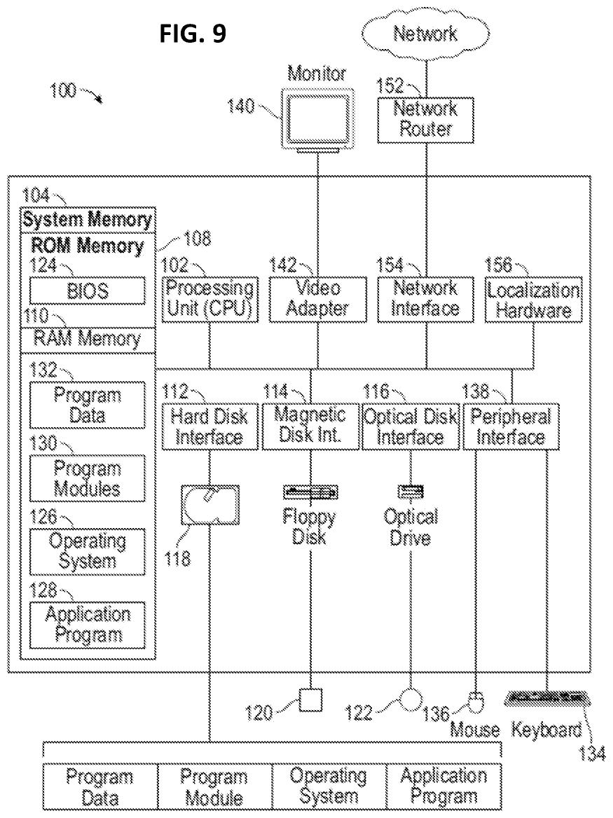

First, with respect to FIG. 1, illustrative systems for generating and providing a URL for a user device to navigate to a webpage related to tangible items for a project or task will be described at a high level. With respect to FIG. 2, an illustrative method for generating and providing a URL for a user device to navigate to a webpage related to tangible items for a project or task will be described at a high level. With respect to FIG. 3, an illustrative method for determining aspects of a user and/or user device and changing a webpage delivered to the user in response to a selection of a generated URL is described. With respect to FIG. 4, an illustrative method for generating a customized URL related to a particular construction, renovation, or landscaping project is described. With respect to FIG. 5, an illustrative graphical user interface (GUI) of an example browser interface for displaying a custom generated URL to a user along with content related to a project or task is described. With respect to FIG. 6, an illustrative graphical user interface (GUI) of an example browser interface for displaying a custom webpage to a user after the user selects a custom generated URL related to a project or task is described. With respect to FIG. 7, an illustrative method for generating and providing customized URLs to in-store users while a payment processing system is unavailable is described. With respect to FIG. 8, illustrative systems for generating and providing customized universal resource locators (URLs) and implementing electronic transactions upon navigation to the URL by a user device will be described. Finally, with respect to FIG. 9, an illustrative computing environment that may be used in conjunction with the methods and processes of this disclosure will be described.

In various embodiments, different computerized devices, systems, aspects are described herein, for example with respect to FIG. 1. Any combination of the various computing components, devices, and/or aspects described herein may be or may include one or more aspects of a computing device or system shown in and described with respect to FIG. 9. For example, user computing devices 162 and 176, omnichannel server(s) 170 (which hereinafter may be referred to as server 170 even though it may be multiple servers), omnichannel database(s) 172 (which hereinafter may be referred to as database 172 even though it may be multiple databases, memory devices, data stores, etc.), contractor computing device 168, content creator computing device 174, network 166, etc. of FIG. 1 may include some, all, or additional computing components as shown in and described with respect to FIG. 9. For example, the user computing devices 162 and/or 176 may select or navigate to a URL using a hyperlink, QR code, etc. as described herein. The server 170 may be referred to as an omnichannel server because the server 170 is used as a single channel to generate and define URLs that are related to the tangible items for certain projects or tasks, provide those URLs to various devices in FIG. 1, assist in serving a webpage in response to a user selection of a URL defined by the server, provide recommendations for shipping/fulfillment and/or payment methods on a display for users to acquire the tangible items, and process payment for such electronic transactions as described herein. In other words, the systems and methods herein provide a single or omni-channel for defining URLs for projects and tasks and providing additional services up to a user purchasing tangible items for that project or task online.

In various embodiments, any of the devices of FIG. 1 may additionally or alternatively be used to implement or execute the methods or processes described herein, such as those described herein with respect to a database, server, cloud service/server, etc. In addition, one or more of the computing devices, systems, etc. described herein may be in communication with any or all of the other devices shown in FIG. 1 to implement the systems and methods described herein (e.g., where one computing device is a virtual machine running instructions stored on and/or executed on another computing device).

In FIG. 1, a block diagram of a system 160 is shown. In this diagram, system 160 includes the user computing devices 162 and 176, the server 170, the database 172, the contractor computing device 168, the content creator computing device 174, and the network 166. Note that many other permutations of this figure are contemplated (as with all figures). While certain connections are shown (e.g. data link connections) between different components, in various embodiments, additional connections and/or components may exist that are not depicted. As will be appreciated, large numbers of devices are omitted from this diagram for simplicity-thus, in various embodiments, routers, switches, load balancers, computing clusters, additional databases, servers, and firewalls, etc., may all be present. Components may be combined with one other and/or separated into one or more systems in this figure, as in other figures.

Note that the server 170 and the database 172 are shown as being connected to the network 166 and to one another, but this architecture is only an example. The server 170 and the database 172 may also be connected to other systems/components, including other backend components of an e-commerce website, such as those shown in and described with respect to FIG. 8. The server 170 and the database 172, as well as any other backend components to which they are connected (e.g., the components of FIG. 8) may comprise one or more computing devices in various embodiments and can be hosted in a cloud environment or other computing cluster environment in various embodiments.

The user computing devices 162, 176 may be any user computer system that can potentially interact with the server 170. The server 170 may facilitate one or more services, such as electronic transactions, online shopping, pricing, delivery/fulfillment, etc. The server 170 may thus also facilitate access to various electronic resources, which can include various data, programs, functionality, etc.

The server 170 may be any computing device configured to provide access to electronic resources. This may include providing web content, in various embodiments, as well as access to functionality provided a web client (or via other protocols, including but not limited to SSH, FTP, database and/or API connections, etc.). For example, the server 170 may have a custom or service specific application programming interface (API) with which it communicates with other components of other services, such as those shown in FIG. 8. Services provided may include serving web pages (e.g. in response to a HTTP request) and/or providing an interface to the user computing devices 162, 176. The database 172 may include various data, such as user account data, system data, item data, other data related to electronic transactions, and/or any other information. Multiple such databases may exist in various embodiments, and may be spread across one or more data centers, cloud computing services, etc. The server 170 may comprise one or more computing devices each having a processor and a memory (e.g., as shown in FIG. 9). The network 166 may comprise all or a portion of the Internet.

The various components of FIG. 1 may carry out various functions and methods described herein. For example, a content creator computing device may be used by a user of the Internet to upload content such as a video or blog post about a home improvement project or task. The video or blog post may include, for example, detailed instructions on how to complete a project or task, such as installing bathroom hardware, a light fixture, building a flower box, assembling yard decorations, finishing/painting a portion of a home or a piece of furniture, etc. The content creator computing device 174 may further be used by a user to request a custom URL from the server 170 related to the project or task. A request for a custom URL from the content creator computing device 174 may include data indicating tangible items used to complete the project or task.

The server 170 may generate the URL and store data in the database 172 relate to the URL. For example, the URL itself may be stored along with information about the tangible items associated with the project or task for which the URL is created. In this way, when a user device has requested navigation to a webpage with the URL, the server 170 can look up in the database 172 what tangible items are related to the URL and add those items to an electronic shopping cart automatically when serving data related to a webpage for the URL, such as when one of the user computing devices 162, 176 selects a hyperlink pointing to the URL or otherwise requests the URL. A contractor computing device 168 may also be configured to request a URL similar to the content creator computing device. However, such requests may further include data related to a labor charge in addition to tangible items related to the task, as is further discussed below with respect to FIG. 4.

FIG. 2 is a flow chart illustrating an example method for generating and providing customized URLs to online users. At an operation 202, a request is received by a processor of a computing device (e.g., the server 170 of FIG. 1) to generate a universal resource locator (URL) for use in a clickable link (e.g., a hyperlink) for display in or as part of a webpage. Such a request may be received prior to receiving data indicative of a request for the URL (or indicative of a user selection of a clickable link), as the URL should be defined prior to using it to direct users to another webpage. The request may include identification of one or more tangible items to be used in a project or task.

At an operation 204, the URL is generated in response to the request to generate the URL. The URL may be generated by the server 170 for example. As described herein, such an operation may further include defining in a database (e.g., the database 172) the URL and its associated tangible items for future references. In various embodiments, as described herein, the URL may take different forms, such as text, a visual code (e.g., QR or similar code), or any other form that a URL, clickable link, hyperlink, etc. may take.

At an operation 206, the URL is sent to a creator computing device (e.g., the content creator device 174 of FIG. 1) configured to upload the video to the first website. The URL may be sent or transmitted by the server 170, for example. The content creator device may be configured to use a third party website as a host for its content (e.g., a video hosting website like YouTube™), and therefore may merely upload a video file, a text description of the video, etc., as opposed to creating a webpage and/or website for their content. In another example, a content creator device may similarly use a third party website to host blog content (e.g., text content) related to the project or task. In some embodiments, a content creator device may create, maintain, and/or host their own website upon which their content is uploaded. In any case, the content creator may use the URL in some way related to their content to be displayed on a webpage along with their content (e.g., as shown in and described with respect to FIG. 5 herein). In this way, the URL may be selected as a clickable link, a code may be scanned and decoded, etc. so that a user computing device may request a webpage using the URL.

At an operation 208, the server may receive first data indicative of a user selection of a clickable link including or incorporating the URL. The clickable link may be displayed on a user computing device as part of a first webpage. In other embodiments, the received first data indicative of a URL may decoded by the user computing device from a visual code scanned or captured by, for example, a camera of the user computing device. In other embodiments, the URL may be received at the user computing device by scanning a near field communication (NFC) device, a Bluetooth device, or any other sort of short range communication device capable of communicating a URL so that the user computing device may then send the URL as a request to the server. In various embodiments, the first webpage may include a video with instructions for a user to complete a project or task, and the project or task may require a plurality of tangible items in order for a user to complete the project or task on their own (e.g., building a do-it-yourself project at home).

At an operation 210, the server may send, in response to the receiving of the first data, second data indicative of a second webpage for display by the user computing device that sent the URL request. The second data indicative of the second webpage may include third data indicative of a virtual shopping cart in which all of the plurality of tangible items are pre-added to the virtual shopping cart automatically. In other words, as described herein, the second webpage may load on a browser of the user computing device with all the tangible items for the project or task already automatically included in an electronic shopping cart on the second webpage, so that the user does not have to add the items to a cart manually should they wish to order the items to complete the project or task at home themselves.

In various embodiments, the first webpage may be part of a first website provided by a first entity and the second webpage may be part of a second website provided by a second entity, such that the first webpage is provided by a different entity than an entity that provides the second webpage. In this way, a user may be able to navigate to a webpage to purchase the tangible items from a website that may have no or little relationship with the entity/website that displays or otherwise incorporates the URL (e.g., a website on which a user purchases the tangible items may be different from a website that hosts content related to completing projects or tasks). In other embodiments, the first webpage and the second webpage may both be part of or hosted by the same website or entity.

FIG. 3 is a flow chart illustrating an example method 300 for determining aspects of a user and/or user device and changing a webpage delivered to the user in response to a selection of a generated URL. For example, like the second webpage may be automatically configured to have items added to an electronic shopping cart, other aspects of the second webpage may be automatically configured based on aspects of a user and/or the user's device as determined by the system (e.g., as determined by the server 170). Such changes may be automatically served to the user device as part of the second webpage. For example, a shipping/fulfillment method may be recommended automatically, which may be reflected on the second webpage as delivered to the user computing device from the server. As another example, a payment method may be recommended automatically, which may also be reflected on the second webpage as delivered to the user computing device from the server.

At an operation 302, the server may determine, based at least in part on or in response to receiving of first data indicative of a user selection of a clickable link or URL, an approximate geographic location of the user computing device. The approximate geographic location may be determined in various ways, such as using a device's internet protocol (IP) address, past activity from the device, networks (e.g., WiFi) currently or previously connected to by the device, known aspects of a user of the device, or from a communication from the device itself if location settings of the user device allow sending of such information to a third party server. This approximate geographic location information may be used to make a recommendation for delivery/fulfillment of the tangible items, a method of payment for the electronic transaction, or both.

At an operation 304, other aspects of a user device or user of the computing device may be determined, estimated, etc. For example, the system may determine a type of device that the user device is (e.g., laptop, desktop, smart phone, tablet), a specific model of device that the user device is, an operating system (OS) that the device uses, what type of network the device is using to access the Internet (e.g., cellular data network, WiFi, etc.), a specific network the device us connected to, an identity of the user, past payment methods used by the user, other payment methods available to the user, past delivery/fulfillment options of the user, an approximate location of a home or work of the user, demographic information of the user, past delivery/fulfillment options used by the user, other delivery/fulfillment options available to the user, or any other aspect of a user or their computing device that may be determined by or known by the system/server.

At an operation 306, the system may determine the availability of the tangible items used for the project or task, for example at different brick and mortar stores, at warehouses, at distribution facilities, etc.

At an operation 308, the system may determine and send data indicative of a recommendation for payment method for the user to acquire the plurality of tangible items. For example, a recommended payment method may be displayed as part of a display or GUI of the user computing device as shown in the example of FIG. 6. The recommendation may be displayed automatically as part of the second webpage by including the recommendation in the second data sent to the user computing device. In other words, the recommendation may be determined and sent along with the webpage that has all the tangible items added to the electronic shopping cart, so that the recommended payment method appears automatically at the user device upon loading/displaying of the second webpage through which an electronic transaction may be executed.

At an operation 310, the system may determine and send, based at least in part on the approximate geographic location of the user computing device, a recommendation for a delivery or other type of fulfillment for the user to receive the tangible items required to complete the project or task. For example, a recommended delivery or fulfillment may be one of same-day delivery service, same-day in-store pickup, multi-day delivery service, multi-day in-store pickup, multi-store pickup or shipping, last mile ship from store to home, last mile ship from multiple stores to home, for the user to acquire the plurality of tangible items. In various embodiments, the server 170 or another server may send a confirmation (e.g., text, email) to the user once their order is ready for pickup (if a pickup option is selected for shipping/fulfillment).

The recommendations determined at the operations 308 and 310 for the recommended payment method and delivery/fulfillment method may be determined based on various information. For example, any of the information determined, collected, deduced, or otherwise ascertained at any of the operations 302, 304, and/or 306 may be used to determine any or all of the recommendations for payment method or delivery/fulfillment at the operations 308 and 310.

In various embodiments, machine learning algorithms, neural networks, artificial intelligence, etc. may be used along with the information ascertained or determined at any of the operations 302, 304, and/or 306 to determine any or all of the recommendations for payment method or delivery/fulfillment at the operations 308 and 310. For example, the information ascertained or determined at any of the operations 302, 304, and/or 306 may be input into a machine learning model or algorithm to train the model or algorithm. Once trained, the machine learning model or algorithm may be used to determine recommendations for payment method and/or delivery/fulfillment options when a URL request is received from a user computing device as described herein. In various embodiments, the machine learning model or algorithm may be further trained based on a training data set. A training data set may include the types of data collected at the operations 302, 304, and/or 306 for various historical electronic transactions processed by the system, and each transaction in the training data set may include an actual payment method and/or delivery/fulfillment option selected or used by a user to process the transaction. In this way, the machine learning model or algorithm may be trained to determine indicators of the types of data collected at the operations 302, 304, and/or 306 that may be indicative of a user preferring one type of payment method or delivery/fulfillment option over others. Therefore, the model or algorithm may be trained using historical electronic transaction data to help determine recommendations in the future. In various embodiments, if a user is known (e.g., has an account with the system), the system may also determine the payment method or delivery/fulfillment options based on that particular user's previous behavior/preference. Other data about users may also be used to train a machine learning model algorithm to better predict what recommendations to provide to users, such as a time of day or day of week users prefer delivery of items, historic location of users, historic availability of items, etc.

In various embodiments, the determining of the recommendation for delivery/fulfillment options may be further determined based at least in part on an availability of the plurality of tangible items at a physical store within a predetermined threshold of the approximate geographic location of the user computing device. In other words, the system may only offer, for example, an in-store pickup as the recommended option if the tangible items are available at a brick and mortar store within a certain threshold distance of where the user computing device is estimated to be. In various embodiments, the recommendation may also or instead be made based on an actual or approximate location of a home or work of the user, such that, for example, in-store pickup may be recommended if the user's home or work is within a certain predetermined threshold distance from the user's home and/or work.

As shown in and described further with respect to FIG. 6 herein, any of the recommendations for payment method and/or delivery/fulfillment options may be displayed automatically as part of the second webpage, because the server may include data indicative of the recommendation(s) in the data sent to the user computing device to cause the user computing device to display the second webpage with the electronic shopping cart and items pre-added. In other words, the system may cause the second webpage to automatically include upon loading it/displaying it on the user computing device (i) all the tangible items for the project or task automatically added to an electronic shopping cart, (ii) a recommended payment option displayed, and (iii) a recommended delivery/fulfillment option displayed. As such, the systems and methods described herein may make it as easy as possible for the user to execute an electronic transaction for acquiring the tangible items. In various embodiments, the user may be able to execute such an electronic transaction as a guest and/or if the user has a user account with the retailer associated with the second website on which the electronic transaction is executed (e.g., on which the tangible items are purchased).

FIG. 4 is a flow chart illustrating an example method 400 for generating a customized URL related to a particular construction, renovation, or landscaping project. In various embodiments, instead of a do-it-yourself type project, a user may desire for a professional contractor to complete a project or task for them, such as a construction, renovation, or landscaping project at their home, business, etc. A user may book or schedule a contractor to perform the construction, renovation, or landscaping project, for example, through a home improvement entity/store that provides such services. As described herein, a URL in accordance with the various embodiments herein may be generated and used by a user and their computing device to easily pay for the construction, renovation, or landscaping project or task in a way that improves on existing methods. In addition to tangible items being added automatically to a electronic shopping cart, a labor service charge may also be added to an electronic shopping cart on a webpage navigated to with the custom URL, where the labor service charge is specific to the user's construction, renovation, or landscaping project or task.

At an operation 402, the system may receive, from a contractor computing device, a request to generate a universal resource locator (URL). For example, the contractor may request a URL when a construction, renovation, or landscaping project or task is to be performed by the contractor. In various embodiments, the server of the system may generate the URL without a specific request from a contractor device, but may rather generate it upon the user scheduling the construction, renovation, or landscaping project or task. In either scenario, the request for the URL from the contractor device may include or the server may receive information related to a labor charge from a contractor device. For example, a contractor may enter a number of hours or estimated cost (e.g., the contractor may enter a bid) for completing the construction, renovation, or landscaping project or task. This information may be used to generate the URL. Information about the labor charge or estimate may be stored in a database along with the URL, so that when the user selects or otherwise navigates to the URL, charges for the labor may be automatically added to the electronic shopping cart similar to the tangible items. As such, whether originating from a contractor device or not, a generated URL at an operation 404 may include information identifying a plurality of tangible items and at least one labor service related to at least one of a construction, renovation, or landscaping project or task.

At an operation 406, the URL may be sent to the contractor device and/or the user device. For example, the URL may be sent to the contractor computing device as a QR code. Then when the contractor is on-site where the construction, renovation, or landscaping is being performed, the user may scan the QR code in order to process an electronic transaction to pay for the construction, renovation, or landscaping. In other embodiments, the URL may be sent to the customer (e.g., via text, email, etc.) so that the user can navigate to a webpage using the URL to pay for the construction, renovation, or landscaping. In other embodiments, the user may book the contractor at a brick-and-mortar store, and a URL or QR code may be included on a printed receipt or other paper given to the user, so that the user can pay for the construction, renovation, or landscaping. In any case, the URL is eventually passed to the user so that the user can navigate to a webpage using the URL.

At an operation 408, data indicative of the URL may be received at the server or system from a customer computing device. In other words, the user device may have successfully scanned a code, received a user interaction to click on a link related to the URL, etc. so that the user device is attempting to navigate to a webpage associated with the URL.

At an operation 410, the server may send, in response to the receiving of the first data indicative of the URL, second data indicative of a webpage for display by the customer computing device. The second data indicative of the webpage may include third data indicative of a virtual shopping cart in which all of the plurality of tangible items and charges for the at least one labor service are pre-added to the virtual shopping cart automatically, as discussed herein. In this way, the user may be able to easily pay for the project, including all labor and materials charges related to the project with a single URL by navigating to a single webpage as described herein.

At an operation 412, the system may receive payment information from the customer computing device. That receiving of payment information may include the user selecting or using a recommended payment method from the system as it appears in the second webpage, for example. The operation 412 may further include causing processing of a payment for the plurality of tangible items and the charges for the at least one labor service based on the payment information received from the customer computing device.

In various embodiments, payment may be processed in different ways. For example, at an operation 414, the system may receive an indication from at least one of the contractor computing device or the customer computing device that the construction, renovation, or landscaping project is completed. The system may only process the payment after such a confirmation is received from the contractor device, customer/user device, or both. In various embodiments, a portion of the payment may be processed before the server receives one or more indications that the construction, renovation, or landscaping project is completed, and a remaining portion of the payment may be processed after the server receives one or more indications that the construction, renovation, or landscaping project is completed. For example, half of the total payment for the construction, renovation, or landscaping project may be processed a predetermined amount of time prior to the contractor being scheduled to begin the project, and half of the total payment for the construction, renovation, or landscaping project is completed may be processed after both the contractor and user devices confirm that the project is adequately completed. In this way, not all of the money is processed for the project prior to the project being completed. However, the user still has a streamlined experience using the URL, as the user may only have to pay or execute an electronic transaction once using the URL.

This may also improve security for the user and the retailer through which the contractor is scheduled, as a contractor on site at a user's home, location, etc. may never handle payment, credit cards, cash, etc. of the user because at most the contractor will just relay the URL to the user, and then the rest of the payment is handled online. As such, the system may process portions of a total payment for the tangible items and the charges for the at least one labor service at different times, including processing a predetermined portion only after the system receives one or more indication that the construction, renovation, or landscaping project is completed.

A similar embodiment may occur if a user is purchasing something over the phone, for example with a customer service agent. By sending a QR code or URL to a user (e.g., via email, text, etc.) that links to a payment page with all the appropriate items automatically added, a user may not need to pass payment option details (e.g., credit card number) over the phone, reducing the likelihood of a customer service agent or a third party listening in to a call from coming into possession of personal payment information of users/customers.

FIG. 5 is an example graphical user interface (GUI) 500 illustrating an example browser interface for displaying a custom generated URL to a user along with content related to a project or task. The GUI 500 includes an address bar 502 that shows a URL of the presently displayed webpage of a website A. In the example of FIG. 5, the website A is a video hosting website, and a video player 504 can display a video relating to a project or task. The GUI 500 may also include an area with a video description 506, which may include a URL as described herein. The URL in the video description 506 (e.g., www.merchantwebsiteB.com/ProjectX) may be recognized by the browser as a URL, and the browser may therefore display the URL as a clickable link. In various other embodiments, not shown, an optical code such as a QR code or a URL/clickable link may be displayed to the user in the GUI 500, such as in the video description 506, as part of the video 504, overlaid on the video, embedded in the video, as part of the video, etc. The video may, for example, include step-by-step instructions for a user to complete the project or task.

A text area 508 may also include instructions for the DIY project and the URL displayed as a clickable link by the browser. In various embodiments, the text area 508 may be similar to what is displayed on a blog webpage where there is no video.

FIG. 6 is an example graphical user interface (GUI) 600 illustrating an example browser interface for displaying a custom webpage to a user after the user selects a custom generated URL related to a project or task. For example, the GUI 600 may be displayed by a browser of a user computing device after a user selects a hyperlink, scans an optical code such as a QR code, etc. and receives information for displaying the second webpage from a server of the system as described herein. An address bar 602 shows that the browser has been navigated to the URL displayed in 506 and 508 of FIG. 5. The GUI 600 further shows that the webpage displayed is part of website B-a different website that FIG. 5 (e.g., website A).

Section 604 of the GUI 600 shows all of the tangible items that were automatically added to the electronic shopping cart 608. Section 606 of the GUI 600 shows a recommended payment method as described herein. However, a user may still be able to select a different payment method, such as those other payment options displayed in the section 606. Section 610 similarly shows a recommended and other delivery/pickup options as described herein. The other delivery/pickup options may also be selected by a user, including selecting which store to pick up items in. The GUI 600 may also include a buy button 612 if the user is happy with the selected items in the cart, the recommended payment option, and the recommended delivery/pickup option. In other words, after selecting a URL or scanning an optical code and their device navigates to the webpage shown in FIG. 6, a user may proceed to execute an electronic transaction to purchase the tangible items for the project or task by selecting the button 612. If the user is known to the website B (e.g., if the user is already signed into a user account), the website B may process the transaction automatically upon the user selection of the button 612. If the user and their payment method details is not known to the website B, additional steps beyond selecting the button 612 may be required for the user to enter further payment information or confirmation of the electronic transaction details, etc. beyond just selecting the button 612. A hand tool (e.g., hammer), hardware (e.g., nails), and lumber are shown as tangible items in FIG. 6. Other tangible items may also be added to an electronic shopping cart depending on the definition of a URL stored in a database for a given project or task. Such tangible items may be, for example, any of a hand tool, a power tool, various types of lumber, various types of building materials, various types of home decorations, various types of lawn decorations, window treatments, bathroom fixtures, kitchen fixtures, lighting fixtures, automotive parts, paints, stains, various types of hardware, etc.

FIG. 7 is a flow chart illustrating an example method 700 for generating and providing customized URLs to in-store users while a payment processing system is unavailable. Another embodiment for the URLs generated by a server for a particular set of tangible items, labor charges, etc. as described herein may be for an in-store purchase when a payment processing system is unavailable or otherwise not working properly.

At an operation 702, a total for a purchase may be determined at a point of sale (POS) terminal. The POS terminal may operate on a different network than a payment processing device or system. As such, the POS terminal may still be able to communicate with a server configured to generate URLs as described herein. In other embodiments, the POS terminal may be able to generate URLs on its own, where each item in the purchase is indicated in the data of the URL. In any case, the POS terminal may be able to determine that a connection for a payment processing system is not available at an operation 704.

At an operation 706, a URL is generated in accordance with the various embodiments herein (e.g., through communication with the server 170 or at the POS terminal). At an operation 710, the POS terminal may display a URL, QR code, etc. so that a customer may scan the QR code or otherwise navigate to a webpage using the URL. That webpage may be a webpage like that in FIG. 6, where all the items scanned at the POS terminal for the purchase may be automatically added to an electronic shopping cart for purchase by the user. The user may then go on to pay for all the items. The user may then show a confirmation to an associate at the POS terminal to take the items. In various embodiments, other methods of confirming that payment has been completed by the user may be used. For example, a payment confirmation code may be sent to the user device (e.g., a QR code), which may be scanned by the POS terminal to verify that payment has been made for the items. In various embodiments, the POS terminal may also communicate with a server to verify that the payment has been completed, either with the code scanned from a user's device or without.

FIG. 8 is a block diagram illustrating an example computer-based system 800 for generating and providing customized universal resource locators (URLs) and implementing electronic transactions upon navigation to the URL by a user device. In the example of FIG. 8, the server 170 may communicate with other devices/servers/services that may be part of an overall e-commerce system. The server 170 may communicate with these devices/servers/services through a network 802 that may be different from, similar to, or the same as the network 166 of FIG. 1. For example, the network 802 may be different from the network 166 to increase security, as the components in FIG. 8 may be backend components of a system. In such a system, the server 170 may be the only aspect of FIG. 8 that communicates with end-user devices through the Internet, for example.

The system 800 includes a token service provider 804, an authorization server 806, a fraud/risk analysis server 808, a fulfillment server 810, a pricing server 812, and a booking/settlement server 814. The server 170 may communicate with any or all of these components to process an electronic transaction, make recommendations for payment options, delivery/fulfillment, etc. For example, the server 170 may communicate with the fulfillment server 810 to determine available fulfillment options to present to a user, determine what tangible items are available and where, etc. In some embodiments, a server may determine replacement items automatically if an item originally requested to be associated with a URL is not currently available. In such embodiments, the database 172 or other databases may include a list of substitutions that may be made, or when a product goes out of stock the database 172 may be updated to only associate in-stock products with URLs saved in the database 172. In other embodiments the server 170 may communicate with a recommender system to recommend a substitution that may be in stock. In some embodiments, substitutions may be specified at the time the URL is created (e.g., specified by the creator of the URL).

The server 170 may also communicate with the pricing server 812 upon receiving an indication that a user has selected a URL. In this way, the server 170 can determine an up to date pricing for the items that are associated with a given URL. In other words, a URL may be defined and associated with specific items, but if the prices for those items change over time, a webpage served to a user device may reflect whatever the current prices for those items are at the given time because the server 170 will check the price upon receipt of an indication of a URL selection and before sending data for the second webpage to the user device.

A fraud/risk analysis server 808 may be used to assess risk for a given order, URL, payment, etc. The booking/settlement server 814 may be communicated with to complete the processing of an order and payment using the systems, methods, GUIs, and computer readable media described herein. The token service provider 804 may be used to tokenize payment information (e.g., credit card information) to provide additional security and anonymization for processing payment for a transaction. The authorization server 806 may be communicated with to authorize the tokenized payment information, and may send a message to the server 170 indicating whether the transaction is approved or not.

FIG. 9 is a diagrammatic view of an example of a computing environment that includes a general-purpose computing system environment 100, such as a desktop computer, laptop, smartphone, tablet, or any other such device having the ability to execute instructions, such as those stored within a non-transient/non-transitory, computer-readable medium/media. Various computing devices as disclosed herein (e.g., the user computing devices 162 and 176, the server 170, the database 172, the contractor computing device 168, the content creator computing device 174, components of the network 166, or any other device) may be similar to the computing system 100 or may include some components of the computing system 100. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 106, respectively, allow for reading from and writing to a hard disk 118, reading from or writing to a removable magnetic disk 120, and/or for reading from or writing to a removable optical disk 122, such as a CD/DVD ROM or other optical media. In various embodiments, other types of memory may be connected to or be part of the system and be accessed via a drive interface connected to the system bus 106, such as flash or solid-state memory devices. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, solid-state memory, flash memory, and/or peripheral memory devices may be used to store computer executable instructions comprising an operating system 126, one or more applications programs 128 (which may include the functionality disclosed herein, for example), other program modules 130, and/or program data 132. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 142. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In some instances, the localization hardware 156 may include, for example only, a GPS antenna, an RFID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

In an illustrative embodiment, any of the operations described herein may be implemented at least in part as computer-readable instructions stored on a computer-readable medium or memory. Upon execution of the computer-readable instructions by a processor, the computer-readable instructions may cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or from practice of the disclosed embodiments. It is intended that the scope of the invention be defined by the claims appended hereto and their equivalents.

What is claimed is:

1. A method, comprising:
receiving, by one or more processors of one or more computing devices, first data indicative of a user selection of a clickable link displayed on a user computing device as part of a first webpage, wherein the first webpage comprises a video comprising instructions for a user to complete a project or task, and further wherein the project or task requires a plurality of tangible items in order for the user to complete the project or task; and
sending, by the one or more processors in response to the receiving of the first data, second data indicative of a second webpage for display by the user computing device, wherein:
the second data indicative of the second webpage comprises third data indicative of a virtual shopping cart in which all of the plurality of tangible items are pre-added to the virtual shopping cart automatically,
the first webpage is part of a first website provided by a first entity,
the second webpage is part of a second website provided by a second entity, and
the first entity is different from the second entity.

2. The method of claim 1, wherein the video comprises step-by-step instructions for the user to complete the project or task.

3. The method of claim 1, wherein plurality of tangible items comprises at least one tool, piece of lumber, building material, home decoration, lawn decoration, window treatment, bathroom fixture, kitchen fixture, lighting fixture, automotive part, paint, stain, or hardware.

4. The method of claim 1, wherein the first website is a video hosting website.

5. The method of claim 1, further comprising receiving, by the one or more processors prior to the receiving of the first data indicative of indicative of the user selection of the clickable link, a request to generate a universal resource locator for use in the clickable link, the request comprising an identification of the plurality of tangible items.

6. The method of claim 5, further comprising generating, by the one or more processors, the universal resource locator in response to the request.

7. The method of claim 6, further comprising sending, by the one or more processors, the universal resource locator to a creator computing device configured to upload the video to the first website.

8. The method of claim 1, further comprising determining, by the one or more processors based at least in part on the receiving of the first data indicative of the user selection of the clickable link, an approximate geographic location of the user computing device.

9. The method of claim 8, further comprising determining, by the one or more processors based at least in part on the approximate geographic location of the user computing device, a recommendation for one of same-day delivery service, same-day in-store pickup, multi-day delivery service, or multi-day in-store pickup for the user to acquire the plurality of tangible items.

10. The method of claim 9, wherein the determining of the recommendation is further determined based at least in part on an availability of the plurality of tangible items at a physical store within a predetermined threshold of the approximate geographic location.

11. The method of claim 9, wherein the recommendation is displayed automatically as part of the second webpage by including the recommendation in the second data sent to the user computing device.

12. The method of claim 1, further comprising determining, by the one or more processors, a recommendation for payment method for the user to acquire the plurality of tangible items, wherein the recommendation is displayed automatically as part of the second webpage by including the recommendation in the second data sent to the user computing device.

13. The method of claim 1, wherein the clickable link is displayed in a description of the video on the first webpage, overlaid on the video, embedded in the video, or as part of the video.

14. A system comprising:
at least one processor; and
a memory operatively coupled to the at least one processor, the memory having non-transitory computer readable instructions stored thereon that, upon execution by the at least one processor, cause the system to:
receive first data indicative of:
a user selection of a clickable link displayed on a user computing device as part of a first webpage; or
a scanning of an optical code displayed on the user computing device as part of the first webpage,
wherein the first webpage comprises at least one of video or text comprising instructions for a user to complete a project or task, and further wherein the project or task requires a plurality of tangible items in order for the user to complete the project or task; and
send, in response to the receiving of the first data, second data indicative of a second webpage for display by the user computing device, wherein:
the second data indicative of the second webpage comprises third data indicative of a virtual shopping cart in which all of the plurality of tangible items are pre-added to the virtual shopping cart automatically.

15. The system of claim 14, wherein the second data includes a first user-specific recommendation for a delivery option for the plurality of tangible items and a second user-specific recommendation for a payment method for acquiring the plurality of tangible items.

16. The system of claim 14, wherein the clickable link or the optical code is displayed in a description of the video on the first webpage, overlaid on the video, embedded in the video, or as part of the video.

17. The system of claim 14, wherein the optical code comprises a QR code.

18. A method comprising:
receiving, by one or more processors of one or more computing devices from a contractor computing device, a request to generate a universal resource locator, the request comprising an identification of a plurality of tangible items and at least one labor service, the plurality of tangible items and the at least one labor service being related to at least one of a construction, renovation, or landscaping project;
generating, by the one or more processors, the universal resource locator in response to the request;
sending, by the one or more processors, the universal resource locator to the contractor computing device associated with the construction, renovation, or landscaping project;
receiving, by the one or more processors from a customer computing device, first data indicative of the universal resource locator; and
sending, by the one or more processors in response to the receiving of the first data, second data indicative of a webpage for display by the customer computing device, wherein:
the second data indicative of the webpage comprises third data indicative of a virtual shopping cart in which all of the plurality of tangible items and charges for the at least one labor service are pre-added to the virtual shopping cart automatically.

19. The method of claim 18, further comprising:
receiving, by the one or more processors, payment information from the customer computing device; and
causing, by the one or more processors, processing of a payment for the plurality of tangible items and the charges for the at least one labor service.

20. The method of claim 18, further comprising:
receiving, by the one or more processors, payment information from the customer computing device;
receiving, by the one or more processors, an indication from at least one of the contractor computing device or the customer computing device that the construction, renovation, or landscaping project is completed; and
causing, by the one or more processors, processing of at least a portion of a payment for the tangible items and the charges for the at least one labor service only after the receiving of the indication that the construction, renovation, or landscaping project is completed.
